(19) United States
(12) Patent Application Publication
(10) Pub. No.: US 2011/0261553 A1
(43) Pub. Date: Oct. 27, 2011

(54) FIRE EMERGENCY ESCAPE GUIDING APPARATUS

(76) Inventor: REN-JIANN LIOU, TAOYUAN (TW)

(21) Appl. No.: 12/877,446

(22) Filed: Sep. 8, 2010

(30) Foreign Application Priority Data
Apr. 23, 2010 (TW) 099207512

(51) Int. Cl. F21V 19/04; F21S 8/00

(52) U.S. Cl. 362/20; 362/145

(57) ABSTRACT

A fire emergency escape guiding apparatus includes at least one laser guider installed at a predetermined position of an escape passage, and a light beam generated by the laser guider has the features of a quick response and a low divergence and provides a clear vision in a dark and smoky environment with a low visibility, such that escape guiding signs and routes can be provided immediately and clearly in the escape passage with the low visibility when a fire breaks out, so as to achieve the effects of improving the rescue rate and reducing casualties.

### BACKGROUND OF THE INVENTION

1. Field of the Invention

The present invention relates to a fire emergency escape guiding apparatus, and more particularly to a fire emergency escape guiding apparatus having the features of simple installation, easy operation, convenience, aesthetic appearance, small size, quick response, and high efficiency for providing immediate and clear escape sign and route for an escape passage to achieve the effect of reducing casualties effectively when a fire breaks out.

2. Description of the Related Art

At present, most indoor facilities and devices used for guiding the direction and route of a fire escape indicate the escape direction and route by labeling arrowhead signs of the escape direction at positions of emergency illumination lamps, sticking the arrowheads sign made of a luminescent material on walls along the escape passage, or installing LED lamps on the walls along the escape passage. However, power failure and smoke generally occur at a fire site, so that the aforementioned methods of labeling arrowhead signs at the positions of the emergency' illumination lamps or sticking luminescent arrowhead signs along the escape passage fail to provide the expected guiding effect due to a poor visibility in a smoky environment. People in panic generally follows the crowd at the front to move forward and may end up with a wrong escape route or result in a too-crowded exit or more casualties. Although the aforementioned method of using LED lamps to indicate the escape route can have a better visibility than the emergency illumination lamp and luminescent signs, the increasingly concentrated smoke reduces the visibility and incurs a poor guiding effect, such that the expected effect cannot be achieved. Furthermore, the high price of LED lamps also lowers a consumer's willingness for installing the LED lamps and the promotion of using the LED lamps. Regardless of the method of using the arrowhead signs installed at the positions of the emergency illumination lamps, the luminescent signal stuck onto the walls along the escape passage, or the LED indicating lamps installed on the walls along the escape passage, a large using area and an ugly appearance also reduce the consumer's willingness of adopting the aforementioned methods.

### SUMMARY OF THE INVENTION

It is a primary objective of the present invention to overcome the shortcomings of the prior art by providing a fire emergency escape guiding apparatus with the features of simple installation, easy operation, convenience, aesthetic appearance, small size, quick response, and high efficiency for providing immediate and clear escape sign and route for an escape passage to achieve the effect of reducing casualties effectively when a fire breaks out.

To achieve the foregoing objective, the present invention provides a fire emergency escape guiding apparatus comprising at least one laser guider installed at a predetermined position of an escape passage and provided for generating a light beam with a quick response and a low divergence, such that a clear vision can be achieved in the low visibility of a smoky or dark environment and an escape guiding signs and route can be provided immediately and clearly in the escape passage under the poor visibility when a fire breaks out, so as to achieve the effects of improving the rate of rescue and reducing casualties.

To make it easy for our examiner to understand the objects, characteristics, and effects of the present invention, we use the following preferred embodiments accompanied with related drawings for the detailed description of the present invention as follows:

### BRIEF DESCRIPTION OF THE DRAWINGS

FIG. 1 is a schematic view of a laser guider operated in a fixed form in an escape passage in accordance with a preferred embodiment of the present invention:

FIG. 2 is a first schematic view of a laser guider operated dynamically with a dynamic object in an escape passage in accordance with a preferred embodiment of the present invention;

FIG. 3 is a second schematic view of a laser guider operated dynamically with a dynamic object in an escape passage in accordance with a preferred embodiment of the present invention; and

FIG. 4 is a schematic view of a laser guider operated with a lens at a stairway in accordance with a preferred embodiment of the present invention.

### DETAILED DESCRIPTION OF THE PREFERRED EMBODIMENTS

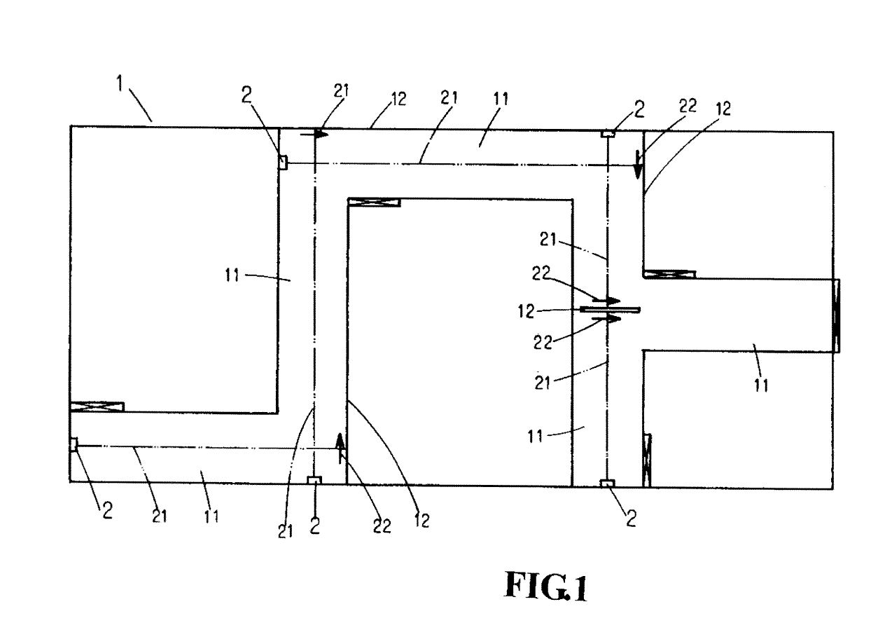

With reference to FIG. 1 for a fire emergency escape guiding apparatus in accordance with the present invention, the fire emergency escape guiding apparatus comprises at least one laser guider 2 installed at a predetermined position of an escape passage 11 of a building 1, wherein a light beam 21 and a guiding sign 22 are produced along an escape route of the escape passage 11 by the laser guider 2 to provide an escape direction, and the laser guider 2 is connected to a fire alarm (not shown in the figure), such that the fire alarm will be turned on automatically when a fire breaks out, or the laser guider 2 is connected to an emergency illumination lamp (not shown in the figure), such that the emergency illumination lamp will be turned on automatically when electric power fails. If the fire alarm or the emergency illumination lamp is turned on during a fire occurred in the building 1, the laser guider 2 will be turned on immediately to generate a light beam 21 to produce a guiding sign 22 (in the shape of an arrowhead) at a position on a wall or a medium surface 12 corresponding to projection of the light beam 21, wherein the laser light is a light beam having the features of quick response and low divergence and providing a clear vision in a dark and smoky environment with a low visibility, so that people in the building 1 can see the escape guidance clearly through the laser beam 21 and the guiding sign 22 even in the dark or smoky environment with a low visibility in the escape passage 11 of the building 1 and escape along the escape route easily, quickly and convenient to achieve the effects of improving the evacuation and rescue rate and reducing casualties.

Since the laser beam 21 and the guiding sign 22 produced by the laser guider 2 are not affected by the dark and smoky environment too much, therefore clear escape direction and routes can be provided in the escape passage 11 during a fire accident. When the invention is applied to a larger public facility, the escape passage can be divided and arranged into different areas appropriately, and the laser guider 2 can guide people in an escape route to the nearest escape exit, such that people in different areas can be guided to escape along an escape route clearly by the laser guider 2 in their area and move quickly to the nearest escape exit if a fire breaks out accidentally, and such arrangement can prevent people to be crowded at the same escape exit, so as to achieve the effects of reducing the danger and improving the evacuation and rescue rate.

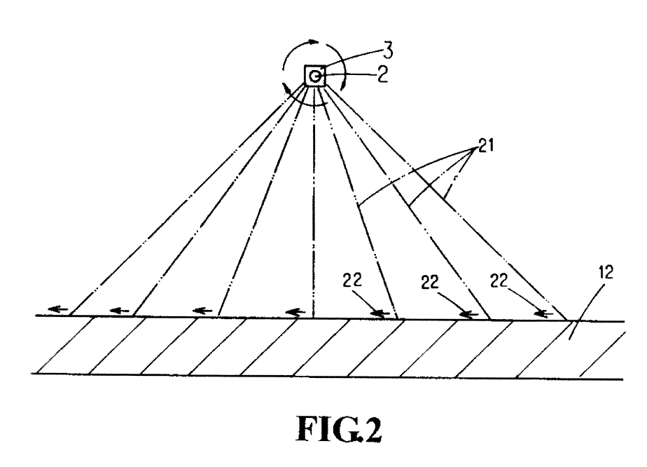

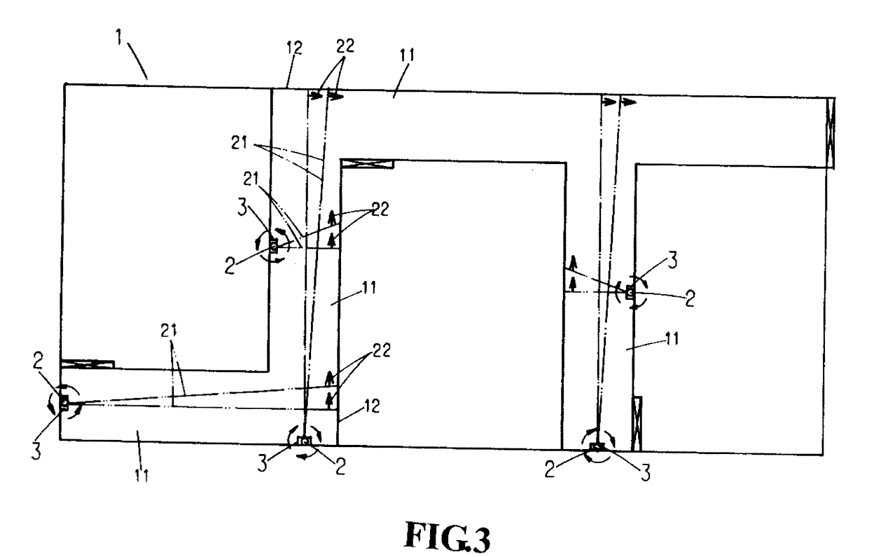

In FIGS. 2 and 3, the laser guider 2 can be installed and combined with a dynamic object 3 as well, in addition to its installation in a fixed form at a predetermined position of the escape passage 11. After the dynamic object 3 is installed at a predetermined position of the escape passage 11, the dynamic object 3 can be rotated or moved to drive the laser guider 2, such that the laser beam 21 and the guiding sign 22 produced by the laser guider 2 can be projected onto a wall or a medium surface 12 to provide a moving status. For different situations, the guiding sign 22 produced by the laser beam can maximize the efficiency and effectiveness of showing the escape route.

The dynamic object 3 can be a transmission motor.

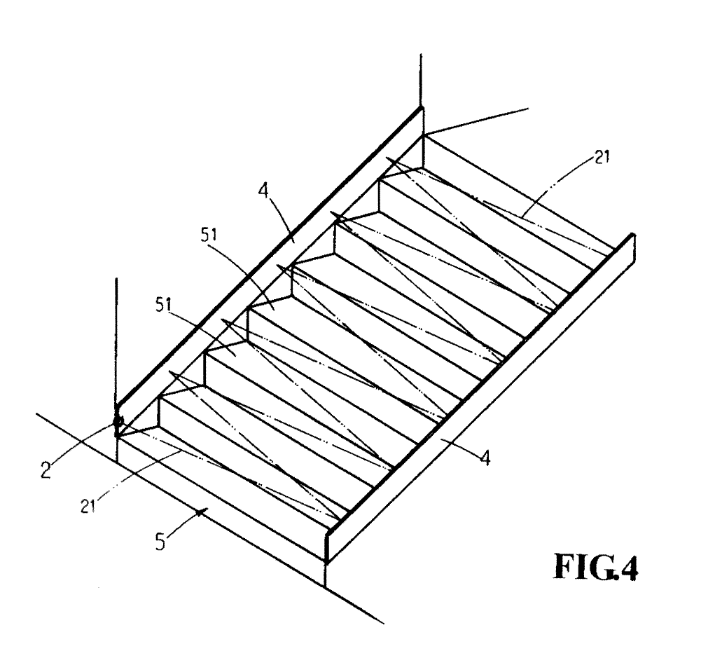

To cope with different situations, the laser guider 2 can be operated with a lens 4 in the escape passage as shown in FIG. 4, wherein the lens 4 can be installed separately on both sides of a stairway 5, and the laser guider 2 is installed at a predetermined position on one side or separately on both sides of the lens 4, such that a light beam 21 generated by the laser guider 2 can be projected onto a mirror surface of the lens 4 to form a refracting network automatically, so as to sufficiently illuminate each step 51 of the stairways 5 and allow a crowd of people to see clearly without the risk of being stumbled, so as to achieve the effects of improving the evacuation and the rescue rate and reducing casualties.

In summation, the present invention has the following advantages;

1. The invention features simple installation, easy operation, convenience and aesthetic appearance.

2. The invention provides a clear and definite escape route at a fire site with heavy smokes to achieve the effects of improving the evacuation and rescue rate and reducing casualties.

What is claimed is:

1. A fire emergency escape guiding apparatus, comprising at least one laser guider installed at a predetermined position of an escape passage of a building for producing a light beam and a guiding sign along an escape route of the escape passage to provide an escape direction.

2. The fire emergency escape guiding apparatus of claim 1, wherein the laser guider is installed and coupled to a dynamic object.

3. The fire emergency escape guiding apparatus of claim 2, wherein the dynamic object is a transmission motor.

4. The fire emergency escape guiding apparatus of claim 1, wherein the laser guider is operated with a lens to form a refracting network from the generated light beam.

5. The fire emergency escape guiding apparatus of claim 1, wherein the laser guider is connected and operated with a fire alarm used when a fire breaks out.

6. The fire emergency escape guiding apparatus of claim 1, wherein the laser guider is connected and operated with an emergency illumination lamp used in a power failure.
